(19) United States
(12) Patent Application Publication
(10) Pub. No.: US 2025/0319926 A1
(43) Pub. Date: Oct. 16, 2025

(54) VEHICLE CONTROL METHOD

(71) Applicant: Panasonic Automotive Systems Co., Ltd., Kanagawa (JP)

(72) Inventors: Naohiko AKAO, Kanagawa Ken (JP); Sotaro IZUMI, Tokyo To (JP); Hirofumi NISHIMURA, Kanagawa Ken (JP)

(73) Assignee: Panasonic Automotive Systems Co., Ltd., Kanagawa (JP)

(21) Appl. No.: 19/086,346

(22) Filed: Mar. 21, 2025

(30) Foreign Application Priority Data
Mar. 26, 2024 (JP) 2024-048891
Jan. 22, 2025 (JP) 2025-009077

(51) Int. Cl. B62D 15/02; B60R 1/27; B60W 30/06

(52) U.S. Cl. CPC B62D 15/0265; B60R 1/27; B62D 15/028; B62D 15/0285; B60R 2300/105; B60R 2300/301; B60R 2300/307; B60R 2300/8093; B60W 30/06

(57) ABSTRACT

A vehicle control device registers a teacher path based on a first situation of an outside while a vehicle performs teacher traveling from a predetermined position to a parking target position after an operation device receives an operation of a passenger. The vehicle control device causes a movement control device to control at least steering to cause the vehicle to autonomously travel from the predetermined position to the parking target position and causes the display device to display a video of the outside based on the teacher path and a second situation of the outside. Furthermore, the vehicle control device highlights an object in the video on the display device and causes the display device to display first display prompting a stop operation of the vehicle. The object does not exist during teacher traveling, exists during autonomous traveling, and exists within a predetermined range from the teacher path.

### CROSS-REFERENCE TO RELATED APPLICATIONS

This application is based upon and claims the benefit of priority from Japanese Patent Application No. 2024-048891, filed on Mar. 26, 2024 and Japanese Patent Application No. 2025-009077, filed on Jan. 22, 2025, the entire contents of which are incorporated herein by reference.

### FIELD

The present disclosure relates to a vehicle control method.

### BACKGROUND

In general, many parking spaces are provided in narrow places in houses, which may make parking difficult. Therefore, there are high needs of automated driving for parking and exiting.

A vehicle control device that performs this type of automated driving is known. For example, a technique is disclosed in which a vehicle is caused to perform teacher traveling from a predetermined position to a parking target position by a manual operation of a driver, a traveling path at the time is preliminarily stored as a teacher path, and the vehicle is caused to autonomously travel along the teacher path in a subsequent parking scene (e.g., see JP 2021-124898 A).

During autonomous traveling along the teacher path, however, there may be an object, which did not exist during teacher traveling. In such a case, conventional techniques may have difficulty in automated parking by autonomous traveling. That is, the conventional techniques may have difficulty in providing preferred parking assistance. An object of the present disclosure is to provide a vehicle control method that can provide more preferred parking assistance.

### SUMMARY

According to the present disclosure, a vehicle control method, which is executed by a vehicle control device mounted in a vehicle including: an operation device that receives an operation of a passenger; a sensor device that acquires a situation of an outside including a video of the outside of the vehicle; a display device that is allowed to be visually recognized by the passenger; and a movement control device that controls at least steering, includes: in response to the operation device receiving the operation of the passenger, registering a teacher path based on a first situation of the outside acquired by the sensor device while the vehicle performs teacher traveling from a predetermined position to a parking target position; based on the teacher path and a second situation of the outside acquired by the sensor device, causing the movement control device to control at least steering to cause the vehicle to autonomously travel from the predetermined position toward the parking target position and causing the display device to display the video of the outside of the vehicle; when the sensor device detects an object, which does not exist during the teacher traveling, exists during autonomous traveling, and exists within a predetermined range from the teacher path, highlighting the object in the video on the display device and causing the display device to display first display prompting a stop operation of the vehicle; based on the teacher path and a third situation of the outside acquired by the sensor device, causing the movement control device to control at least steering to cause the vehicle to autonomously travel from the predetermined position toward the parking target position, and causing the display device to display the video of the outside of the vehicle; and when the sensor device does not detect the object, which does not exist during the teacher traveling, exists during the autonomous traveling, and exists within the predetermined range from the teacher path, causing the movement control device to control at least steering to cause the vehicle to autonomously travel to the parking target position based on the teacher path and the third situation of the outside acquired by the sensor device.

### BRIEF DESCRIPTION OF THE DRAWINGS

FIG. 1 is a block diagram illustrating an example of an overall configuration of a vehicle;

FIG. 2 is a schematic diagram illustrating an example of the arrangement of in-vehicle cameras;

FIG. 3 is a schematic diagram illustrating an example of an appearance configuration of the vehicle;

FIG. 4 illustrates an example of a configuration in the vicinity of a driver seat of the vehicle of the embodiment;

FIG. 5 is an explanatory diagram of an example of a teacher path;

FIG. 6 illustrates an example of a data configuration of teacher path data;

FIG. 7 is a schematic diagram of an example of map data;

FIG. 8 is a schematic diagram illustrating an example of a screen displayed on a display device;

FIG. 9 is a schematic diagram illustrating an example of the screen displayed on the display device;

FIG. 10 is a flowchart illustrating an example of a flow of information processing executed by a controller in a teacher traveling mode;

FIG. 11 is a flowchart illustrating an example of a flow of information processing executed by the controller in an autonomous traveling mode;

FIG. 12 is an explanatory diagram of an example of parking assistance given by the controller of an embodiment;

FIG. 13A is an explanatory diagram of an example of an avoidance path;

FIG. 13B is an explanatory diagram of an example of an avoidance path;

FIG. 14 is a flowchart illustrating an example of a flow of information processing executed by the controller in an autonomous traveling mode; and

FIG. 15 is a block diagram illustrating an example of a hardware configuration of a vehicle control device.

### DETAILED DESCRIPTION

Embodiments of a vehicle control method and a vehicle control device according to the present disclosure will be described below with reference to the accompanying drawings. Note that, in the following description of the embodiments, the same reference signs are given to the same parts, and redundant description will be omitted.

### First Embodiment

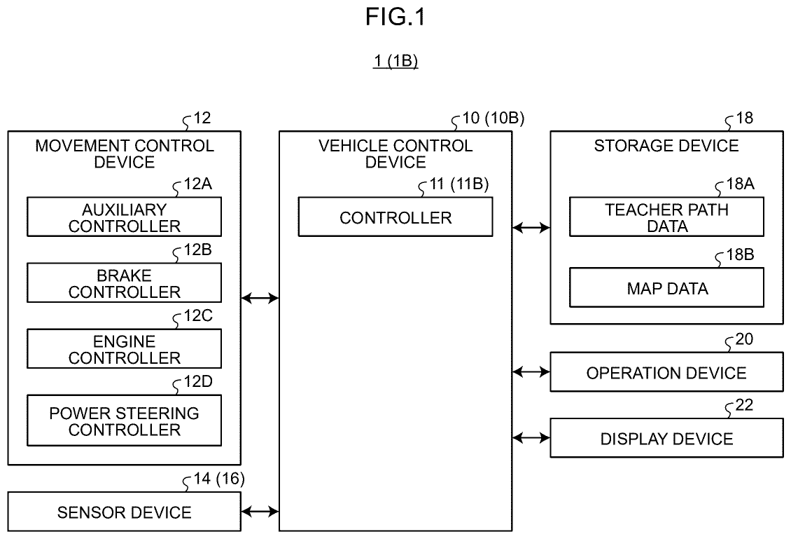

FIG. 1 is a block diagram illustrating an example of an overall configuration of a vehicle 1.

The vehicle 1 includes a vehicle control device 10, a movement control device 12, a sensor device 14, a storage device 18, an operation device 20, and a display device 22.

The movement control device 12, the sensor device 14, the storage device 18, the operation device 20, and the display device 22 are connected to the vehicle control device 10 so as to be able to transfer data or signals. That is, the vehicle control device 10 is set to be communicably connected to at least the sensor device 14, the operation device 20, the display device 22, and the movement control device 12.

The movement control device 12 controls at least acceleration/deceleration and steering of the vehicle 1. The movement control device 12 is an instrument for achieving driving, braking, and turning motions necessary for traveling of the vehicle 1. For example, the movement control device 12 includes a drive motor, a power transmission mechanism, a brake device, a steering device, and an electronic vehicle control device that controls the drive motor, the power transmission mechanism, the brake device, and the steering device. The movement control device 12 causes the vehicle 1 to travel by, for example, generating power with the drive motor and transmitting the power to wheels via the power transmission mechanism. Examples of the power transmission mechanism include a propeller shaft, a differential gear, and a drive shaft.

Controlling at least steering means that the movement control device 12 controls at least one of driving, braking, and turning motions necessary for traveling of the vehicle 1. That is, controlling steering means that the movement control device 12 controls at least one of a turning direction by steering, a vehicle speed and acceleration by accelerator steering, and deceleration and stop by brake steering. Controlling at least acceleration/deceleration means that the movement control device 12 controls at least one of acceleration and deceleration of the vehicle 1.

Specifically, the movement control device 12 includes an auxiliary controller 12A, a brake controller 12B, an engine controller 12C, and a power steering controller 12D. The brake controller 12B, the engine controller 12C, and the power steering controller 12D can be collectively referred to as an actuator controller that controls the operation of the vehicle 1.

The auxiliary controller 12A monitors the transmission state of the vehicle control device 10, and operates to execute appropriate degeneracy control as backup in a case where the vehicle control device 10 fails. Note that even in the case where the vehicle control device 10 fails, the degeneracy control is unnecessary if safety can be secured by providing a degeneracy control function in the vehicle control device 10.

The brake controller 12B performs brake control of the vehicle 1. The brake control may be referred to as braking force control. For example, the brake controller 12B performs the brake control of the vehicle 1 in accordance with enhancement and relaxation of the operation on a brake pedal performed by a passenger. Specifically, the enhancement of the operation on a brake pedal performed by a passenger means a push of the brake pedal given by the passenger. Furthermore, the brake controller 12B performs brake control in accordance with a peripheral video during autonomous traveling.

The engine controller 12C controls an engine that generates driving force of the vehicle 1. The power steering controller 12D controls power steering of the vehicle 1.

The sensor device 14 is mounted on the vehicle 1, and acquires at least a situation of the outside of the vehicle 1. Specifically, the sensor device 14 includes various sensors that detect a traveling state of the vehicle 1 and a situation of the outside of the vehicle 1. The situation of the outside includes a video of the outside of the vehicle 1.

The sensor device 14 includes at least a camera 16. Furthermore, the sensor device 14 includes at least one of light detection and ranging (LiDAR), radar, sonar, an ultrasonic sensor, and the like. The sensor device 14 includes: for example, an accelerator opening sensor; a steering angle sensor; an acceleration sensor; a torque sensor; a vehicle speed sensor; a wheel speed sensor; and a global positioning system (GPS). The accelerator opening sensor detects accelerator opening. The steering angle sensor detects a steering angle of a steering device. The acceleration sensor detects acceleration acting in the front-rear direction of the vehicle 1. The torque sensor detects torque acting on the power transmission mechanism between wheels and a drive motor of the vehicle 1. The vehicle speed sensor detects the vehicle speed of the vehicle 1. The sensor device 14 outputs sensor information obtained by detection to the vehicle control device 10.

The camera 16 is a surrounding sensor that is mounted on the vehicle 1 and that monitors the surrounding environment of the vehicle 1. In the embodiment, the camera 16 captures images of the surroundings of the vehicle 1, and outputs captured video data to the vehicle control device 10. In the following description, the captured video data may be simply referred to as a video. Furthermore, in the embodiment, the camera 16 is also applied to an application in which an object around the vehicle 1 is detected and the existing position of the vehicle 1 is estimated from the positional relation between the vehicle 1 and the object around the vehicle 1.

The position, the number of installations, and the imaging direction of the camera 16 are preliminarily adjusted so that the camera 16 can capture images of the surroundings of the vehicle 1. For example, the vehicle 1 is provided with four cameras 16 arranged so as to be able to capture images in four directions of a front direction, a rear direction, a left direction, and a right direction of the vehicle 1. Note that the number of cameras 16 provided in the vehicle 1 is not limited to four.

The storage device 18 stores various types of data. In the embodiment, the storage device 18 stores data such as teacher path data 18A and map data 18B. Details of the teacher path data 18A and the map data 18B will be described later.

The storage device 18 is, for example, an auxiliary storage device such as a hard disk drive (HDD), a solid state drive (SSD), and a flash memory. Note that an external storage device may store at least a part of data included in the storage device 18. The external storage device includes, for example, a server device provided outside the vehicle 1 and communicably connected to the vehicle control device 10.

The operation device 20 receives an operation from a passenger of the vehicle 1. The operation device 20 includes an operation mechanism related to a driving operation and an input device. The operation mechanism includes a steering wheel, a shift lever for shifting a transmission, an accelerator pedal, a brake pedal, a blinker lever, and a push-in switch. The input device includes a keyboard, a touch panel, and a switch. The steering angle of the steering device is adjusted by an operation on a steering operation unit performed by the passenger. At least one of the keyboard, the touch panel, and the switch functions as an automated parking instruction unit that receives an automated parking start instruction. The steering wheel is an example of the steering operation unit. The steering wheel may be referred to as a wheel. In the embodiment, autonomous parking and autonomous traveling may be referred to as automated parking and automatic traveling, respectively.

The shift lever is an example of a forward movement/rearward movement operation unit. The forward movement/rearward movement operation unit switches between at least forward movement and rearward movement of the vehicle 1. The brake pedal is an example of a brake operation unit. The brake operation unit is provided for a brake that inhibits the speed of the vehicle 1. That is, the brake operation unit receives an instruction to decelerate the vehicle 1. The operation device 20 may constitute a part of a human machine interface (HMI) or an in-vehicle infotainment (IVI).

The display device 22 is a display that outputs various images. The display device 22 is installed at a position that can be visually recognized by the passenger of the vehicle 1. Examples of the display include a liquid crystal display (LCD), an organic electro-luminescence (EL) display, and a projector. A touch panel display in which the display device 22 and the operation device 20 are integrated may be used. The display device 22 is an example of at least one of the HMI and the IVI.

Note that the display device 22 is not limited to a display device including only one display area. For example, the display device 22 may include a plurality of display areas.

Furthermore, the vehicle 1 may include a plurality of display devices 22. For example, the display device 22 may include a first display unit and a second display unit. The first display unit and the second display unit are displays that output various images. The first display unit and the second display unit separately constitute the display device 22. The first display unit and the second display unit may be disposed at different positions in the vehicle 1. For example, the first display unit may function as an IVI, and the second display unit may function as a part of an instrument panel of the vehicle 1.

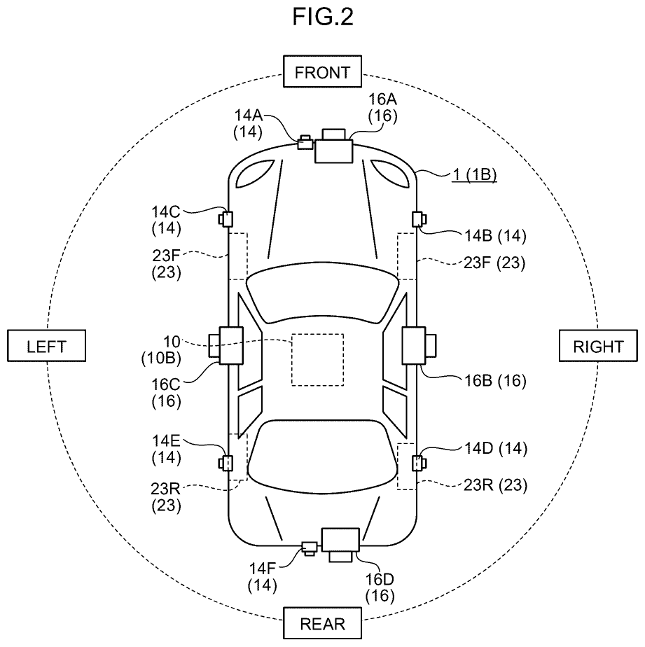

FIG. 2 is an explanatory diagram of an example of the arrangement of the sensor device 14 and the camera 16.

The vehicle 1 is provided with, for example, four cameras 16 (cameras 16A to 16D) so as to be able to acquire a situation of the outside of the vehicle 1 in at least four directions of the front, rear, right, and left of the vehicle 1, for example.

Specifically, for example, the camera 16 includes a camera 16A, a camera 16B, a camera 16C, and a camera 16D. The camera 16A is disposed in a front portion of the vehicle 1, and captures an image of the front of the vehicle 1. The camera 16A is an example of a first camera. The camera 16A may be referred to as a front camera. The camera 16B is disposed in a right portion of the vehicle 1, and captures an image of the right side of the vehicle 1. The camera 16B is an example of a second camera. The camera 16C is disposed in a left portion of the vehicle 1, and captures an image of the left side of the vehicle 1. The camera 16C is an example of a third camera. The camera 16D is disposed in a rear portion of the vehicle 1, and captures an image of the rear of the vehicle 1. The camera 16D is an example of a fourth camera. The camera 16D may be referred to as a rear camera, a rear portion camera, or the like.

A controller 11 of the vehicle control device 10 to be described later may use data on a peripheral video captured by, particularly, the camera 16D, which is a rear portion camera, among the plurality of cameras 16 provided on the vehicle 1 for detecting a planned parking position to be described later. Details of the data on a peripheral video, the planned parking position, and the like will be described later.

Note that the number of cameras 16 provided in the vehicle 1 is not limited to four. Furthermore, the arrangement positions and the number of arrangements of sensors that detect an object, such as LiDAR, radar, sonar, and an ultrasonic sensor included in the sensor device 14, are also preferably adjusted preliminarily so that the sensors can acquire the situation of the outside of each of the right, the left, the front, and the rear of the vehicle 1. For example, as illustrated in FIG. 2, the sensor device 14 includes sensor devices 14A to 14F. The sensor devices 14A to 14F are disposed in the vehicle 1 so as to be able to acquire the situation of the outside of each of the right, the left, the front, and the rear of the vehicle 1. Note that the sensor device 14 that detects an object, such as LiDAR, radar, sonar, and an ultrasonic sensor, may be disposed only in the rear portion of the vehicle 1.

Next, a configuration of the vehicle 1 will be described.

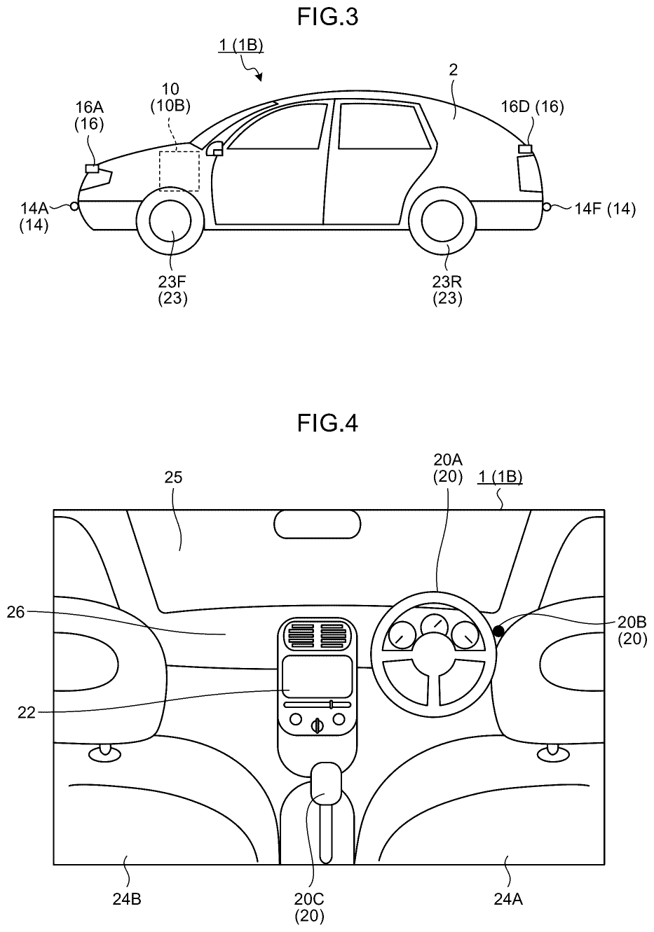

FIG. 3 is a schematic diagram illustrating an example of an appearance configuration of the vehicle 1. The vehicle 1 includes a vehicle body 2 and two pairs of wheels 23 arranged along a predetermined direction on the vehicle body 2. The two pairs of wheels 23 include a pair of front tires 23F and a pair of rear tires 23R (see also FIG. 2). Note that FIGS. 2 and 3 illustrate an example in which the vehicle 1 includes four wheels 23. The number of wheels 23 provided in the vehicle 1 is, however, not limited thereto.

Next, a configuration in the vicinity of a driver seat of the vehicle 1 of the embodiment will be described.

FIG. 4 illustrates an example of a configuration in the vicinity of a driver seat 24A of the vehicle 1 of the embodiment.

The vehicle 1 includes the driver seat 24A and a front passenger seat 24B. A windshield 25, a dashboard 26, a steering wheel 20A, an operation button 20B, and the display device 22 are provided in front of the driver seat 24A. Furthermore, a shift lever 20C for shifting a transmission is provided in the vicinity of the driver seat 24A.

The steering wheel 20A, the operation button 20B, and the shift lever 20C are examples of the operation device 20.

The steering wheel 20A is provided in front of the driver seat 24A, and can be operated by a passenger. The rotation angle of the steering wheel 20A, that is, a steering angle is electrically or mechanically interlocked with a change in the orientation of the front tires 23F, which are steered wheels. Note that the steered wheels may be the rear tires 23R, or both the front tires 23F and the rear tires 23R may be the steered wheels.

The operation button 20B can receive an operation from the passenger. Furthermore, the operation button 20B may include a direction indicator. The position of the operation button 20B is not limited to that in the example in FIG. 4. For example, the operation button 20B may be provided on the steering wheel 20A. Furthermore, although FIG. 4 illustrates one operation button 20B, a plurality of operation buttons 20B may be provided. When the display device 22 also serves as a touch panel, the display device 22 may be an example of the operation device 20.

Returning to FIG. 1, the description will be continued.

The vehicle control device 10 is an electronic control unit that integrally controls each unit of the vehicle 1.

The vehicle control device 10 controls the movement control device 12 to optimize the traveling state of the vehicle 1 by using sensor information received from the sensor device 14. Furthermore, the vehicle control device 10 controls the movement control device 12 to cause the vehicle 1 to autonomously travel.

The vehicle control device 10 includes the controller 11. A part or all of the controller 11 may have a software configuration implemented by cooperation of a processor and various programs stored in a memory. Furthermore, a part or all of the controller 11 may have a hardware configuration implemented by a dedicated circuit or the like.

The controller 11 integrally controls each unit of the vehicle 1.

In the embodiment, the controller 11 can switch a traveling mode to a teacher traveling mode or an autonomous traveling mode based on, for example, an input operation on the operation device 20 performed by the passenger. Note that a traveling mode that can be executed by the vehicle 1 may include various traveling modes other than the teacher traveling mode and the autonomous traveling mode.

The teacher traveling mode is used for registering a teacher path in a case where the vehicle 1 autonomously travels. The teacher path is obtained by teacher traveling from a predetermined position to a parking target position. In the teacher traveling mode, traveling of the vehicle 1 is controlled by an operation of the passenger. That is, in the teacher traveling mode, the controller 11 controls the movement control device 12 so that the operation device 20 receives an operation, which is a driving operation performed by the passenger, and traveling is performed in accordance with the operation. In other words, in the teacher traveling mode, the controller 11 registers a teacher path based on a situation of the outside acquired by the sensor device 14 during teacher traveling in which the vehicle 1 travels from the predetermined position to the parking target position through an operation of the passenger. The situation of the outside acquired by the sensor device 14 during teacher traveling will be hereinafter referred to as a first situation.

In the autonomous traveling mode, the vehicle 1 autonomously travels. In the embodiment, the autonomous traveling mode means a mode in which the vehicle 1 autonomously travels along a teacher path. In the autonomous traveling mode, the controller 11 controls at least steering, and controls the movement control device 12 so that traveling is performed along a teacher path. In the autonomous traveling mode, traveling of the vehicle 1 is automatically controlled by the vehicle control device 10 without a manual operation of the passenger. That is, in the autonomous traveling mode, the controller 11 controls at least steering, and causes the vehicle 1 to autonomously travel from the predetermined position to the parking target position based on the situation of the outside acquired by the sensor device 14 based on the teacher path. The situation of the outside acquired by the sensor device 14 during autonomous traveling will be hereinafter referred to as a second situation of a third situation.

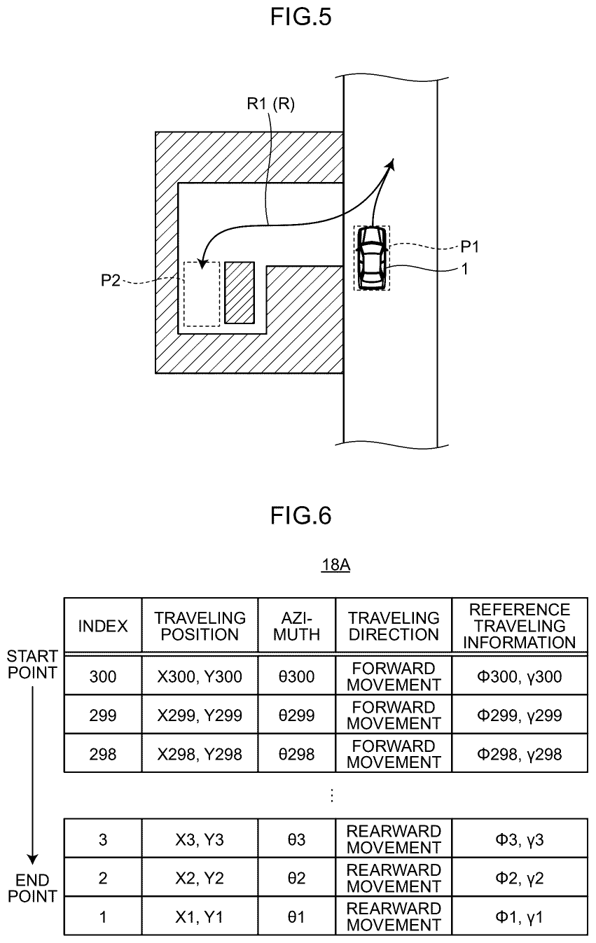

FIG. 5 is an explanatory diagram of an example of a teacher path R1.

In the teacher traveling mode, teacher traveling is performed from a predetermined position P1 to a parking target position P2 by a manual operation on the operation device 20 performed by the passenger. Although examples of the parking target position P2 include a parking lot, this is not a limitation. Furthermore, the predetermined position P1 is only required to be any position of the passenger in real space.

A traveling path R along which teacher traveling has been performed is treated as the teacher path R1. The storage device 18 stores the teacher path data 18A of the teacher path R1. During teacher traveling, for example, the passenger operates the operation device 20 so that traveling is performed from the parking target position P2 toward the predetermined position P1. When the vehicle 1 travels from the predetermined position P1 toward the parking target position P2 during teacher traveling, the controller 11 creates the teacher path data 18A of the teacher path R1 along a traveling direction during the teacher traveling of the traveling path R.

In the autonomous traveling mode, the controller 11 controls at least steering along the teacher path R1 obtained by teacher traveling, and causes the vehicle 1 to autonomously travel from the predetermined position P1 to the parking target position P2 based on the teacher path R1 and the second situation. Note that, in the autonomous traveling mode, the controller 11 executes steering control and front/rear acceleration/deceleration control on the vehicle 1. At least a part of the front/rear acceleration/deceleration control may be executed by an operation of a driver.

Next, control performed by the controller 11 in each of the teacher traveling mode and the autonomous traveling mode will be described in detail.

### In Teacher Traveling Mode

First, the control of the controller 11 in the teacher traveling mode will be described in detail.

When receiving a signal representing a teacher traveling mode start instruction through, for example, an operation on the operation device 20 performed by the passenger, the controller 11 switches the traveling mode to the teacher traveling mode. Then, the controller 11 executes the following processing in the teacher traveling mode.

The controller 11 acquires sensor information indicating the traveling state of the vehicle 1 from the sensor device 14. Then, the controller 11 estimates the current position of the vehicle 1 based on a temporal change of a sensor value represented by the sensor information. For example, the controller 11 calculates an amount of movement of the vehicle 1 from a reference position such as a traveling start position at the time of start of the teacher traveling mode based on temporal changes in a vehicle speed and a yaw rate represented by sensor values, and estimates the current position of the vehicle 1 based on the movement amount.

Note that the accuracy of estimation of the current position based on a movement amount may be low. Therefore, the controller 11 may use, as the current position, a result of correcting the estimated current position based on a video of the surroundings of the vehicle 1 acquired by the camera 16.

The controller 11 causes the storage device 18 to sequentially store the current positions of the vehicle 1 sequentially estimated along traveling of the vehicle 1. Specifically, the controller 11 sets, as the teacher path R1, the traveling path R during teacher traveling represented by a group of the current positions sequentially estimated from a time point when the teacher traveling mode start instruction was received to when a teacher mode end instruction is received, and causes the storage device 18 to store the teacher path data 18A representing the teacher path R1. Furthermore, the controller 11 causes the storage device 18 to store the map data 18B.

FIG. 6 illustrates an example of a data configuration of the teacher path data 18A.

The teacher path data 18A includes a group of pieces of traveling information for positions, which are current positions sequentially estimated during teacher traveling. The traveling information includes INDEX, traveling position, azimuth, traveling direction, and reference traveling information. INDEX is identification information of traveling information. The traveling position is an estimated position of the vehicle 1. The azimuth indicates the orientation of the vehicle 1 at the position. The traveling direction indicates a direction of traveling of the vehicle 1 at the position, and is represented by, for example, forward movement or rearward movement. The reference traveling information represents a traveling state and the like at the position. Examples of the reference traveling information include a steering angle and a vehicle speed detected at each position during teacher traveling.

Furthermore, during teacher traveling of the vehicle 1, the controller 11 creates the map data 18B for estimating the current position of the vehicle 1 from a video captured by the camera 16. A simultaneous localization and mapping (SLAM) method or the like are used as a method for estimating the current position of the vehicle 1 from a video.

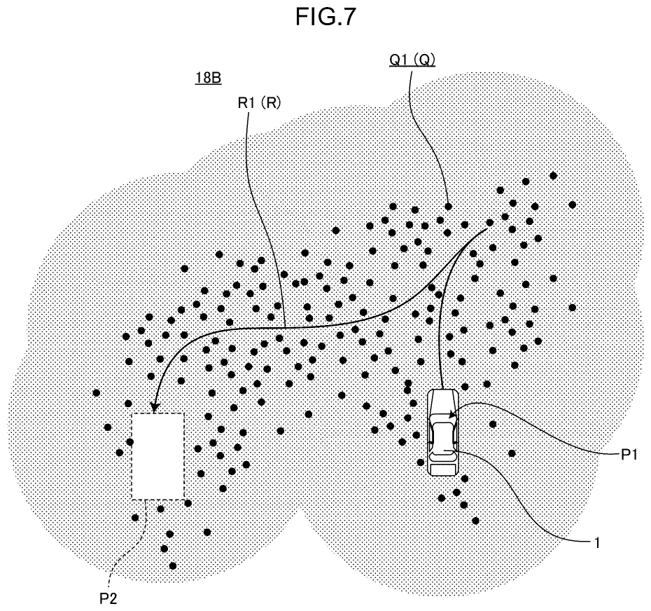

FIG. 7 is a schematic diagram of an example of the map data 18B. FIG. 7 illustrates, in the form of a bird's-eye view, the positions in real space of first feature points Q1 in a real view stored in the map data 18B.

In the map data 18B, a plurality of first feature points Q1 around the vehicle 1 during traveling along the teacher path R1 is registered.

The first feature points Q1 are obtained by analyzing the first situation in, for example, a video captured by the camera 16 during teacher traveling. That is, in the description of the embodiment, feature points Q identified in accordance with the first situation during teacher traveling are referred to as the first feature points Q1.

For example, the feature points Q are portions, in which a characteristic image pattern is obtained by analyzing a video, in an object (e.g., tree, wall, and column) included in the real view. Examples of the portions include an edge portion of the above-described object. That is, in the description of the embodiment, feature points Q identified during teacher traveling are referred to as the first feature points Q1. Therefore, the map data 18B includes a plurality of first feature points Q1. Each of the first feature points Q1 is identifiably registered by giving an identification number to each of the first feature points Q1.

The feature points Q are represented by feature point data including three-dimensional positions and feature amounts.

The three-dimensional positions of the feature points Q are set in real space of the feature points Q, and represented by, for example, a three-dimensional orthogonal coordinate system (X, Y, and Z).

The feature amounts of the feature points Q are characteristic amounts, which are represented by image analysis on a video, of the feature points Q. Examples of the feature amounts of the first feature points Q1 include luminance and density of a video, a scale invariant feature transform (SIFT) feature amount, and a speeded up robust features (SURF) feature amount.

In the map data 18B, one first feature point Q1 is registered for the same three-dimensional position. Note that, in the map data 18B, a plurality of first feature points Q1 may be registered for the same three-dimensional position for positions and directions of image capturing performed by cameras 16 at the three-dimensional position. Furthermore, the feature point data of the first feature points Q1 registered in the map data 18B may further include image data on an object including the first feature points Q1.

During teacher traveling, the controller 11 identifies the coordinates of first feature points Q1 in the real view by using stereo photogrammetry from the first situation, for example. Specifically, the controller 11 reads a plurality of captured images captured at different timings constituting a video included in the first situation, and associates the same first feature points Q1 commonly appearing in the plurality of captured images with each other. Then, for example, the controller 11 estimates a temporary position of the vehicle 1 at the time when the plurality of captured images was captured, and identifies temporary coordinates of the first feature points Q1 in the real view based on the principle of triangulation. Then, the controller 11 performs bundle adjustment by using, for example, the temporary position of the vehicle 1 and the temporary coordinates of the first feature points Q1 in the real view as reference information. The controller 11 calculates the formal position of the vehicle 1 and the formal coordinates of the first feature points Q1 in the real view so as to minimize a reprojection error in a case of projecting each of the first feature points Q1 in the real view to all the captured images. Then, the controller 11 causes the storage device 18 to store the map data 18B in which the first feature points Q1 are registered. The first feature points Q1 are represented by feature point data including, as a three-dimensional position, formal coordinates of the first feature points Q1 in the real view. The three-dimensional positions of the first feature points Q1 registered in the map data 18B may be preliminarily measured by using light detection and ranging (LiDAR) or a stereo camera without using the SLAM method. Note, however, that the SLAM method is preferably used from the viewpoint of inhibiting a decrease in position estimation accuracy.

Returning to FIG. 1, the description will be continued.

As described above, the controller 11 executes the above-described processing in the teacher traveling mode. Therefore, in the teacher traveling mode, the teacher path data 18A and the map data 18B are registered based on the first situation of the outside acquired by the sensor device 14 during teacher traveling. In other words, the controller 11 generates the teacher path data 18A of the teacher path R1 and the map data 18B based on the first situation, and causes the storage device 18 to store the teacher path data 18A of the teacher path R1 and the map data 18B. The teacher path data 18A of the teacher path R1 has been obtained by teacher traveling from the predetermined position P1 to the parking target position P2. The three-dimensional positions of a plurality of first feature points Q1 around the vehicle 1 during traveling along the teacher path R1 and feature amounts of the first feature points Q1 are registered in the map data 18B. Therefore, the storage device 18 stores the teacher path data 18A and the map data 18B. A group of pieces of traveling information on positions, which are the current positions sequentially estimated during teacher traveling, constitutes the teacher path data 18A. The first feature points Q1, which have been observed at the positions, are registered in the map data 18B.

### In Autonomous Traveling Mode

Next, the control of the controller 11 in the autonomous traveling mode will be described in detail.

When receiving a signal representing an autonomous traveling mode start instruction through an operation of the operation device 20 performed by the passenger and the like, the controller 11 switches a traveling mode to the autonomous traveling mode. Then, the controller 11 executes the following processing in the autonomous traveling mode.

The controller 11 reads the teacher path data 18A and the map data 18B from the storage device 18, and controls the movement control device 12 so that autonomous traveling is performed along the teacher path R1 represented by the teacher path data 18A.

The controller 11 estimates the current position of the vehicle 1 based on the map data 18B and a video of the periphery of the vehicle 1 acquired by at least one camera 16.

For example, the controller 11 collates second feature points Q2 with the first feature points Q1 by using pattern matching, feature amount search, or the like. The second feature points Q2 have been identified from the second situation including a video of the camera 16. The first feature points Q1 have been identified from the first situation stored in the map data 18B.

The second feature points Q2 are obtained by analyzing the second situation in, for example, a video captured by the camera 16 during autonomous traveling along the teacher path R1. That is, in the description of the embodiment, feature points Q identified in accordance with the second situation during autonomous traveling along the teacher path R1 are referred to as the second feature points Q2. The controller 11 is required to identify the second feature points Q2 during autonomous traveling along the teacher path R1 by using a method similar to the method of identifying the first feature points Q1 during teacher traveling.

The controller 11 randomly selects several (e.g., 3 to 6) second feature points Q2 from second feature points Q2, which have been identified during autonomous traveling and were successfully collated with the first feature points Q1 stored in the map data 18B.

Then, the controller 11 estimates the current position of the vehicle 1 in real space based on the positions in a video of the several second feature points Q2 and the three-dimensional positions in the real space of the first feature points Q1 registered in the map data 18B corresponding to the several second feature points Q2. In the case, the controller 11 estimates the current position of the vehicle 1 by solving a PnP problem by using a known method (e.g., Literature: Mikael Persson et al. “Lambda Twist: An Accurate Fast Robust Perspective Three Point (P3P) Solver.”, ECCV 2018, pp 334-349, published in 2018, http://openaccess.thecvf.com/content_ECCV_2018/papers/Mikael_Persson_Lambda_Twist_An_ECCV_2018_paper.pdf) such as Lambda Twist.

Through these pieces of processing, the controller 11 estimates, as current position information representing the current position of the vehicle 1, current position information including information related to the two-dimensional position (X coordinate, Y coordinate) of the vehicle 1 in the real space and a posture, which is the orientation of the vehicle 1, based on the map data 18B and a video of the periphery of the vehicle 1 acquired by at least one camera 16.

Then, the controller 11 causes the vehicle 1 to autonomously travel from the predetermined position P1 toward the parking target position P2 along the teacher path R1 by controlling the movement control device 12 so that the estimated current position of the vehicle 1 is provided on the teacher path R1 represented by the teacher path data 18A. Then, the controller 11 stops the vehicle 1 at the parking target position P2.

During autonomous traveling of the vehicle 1 along the teacher path R1, the controller 11 performs feedback control on the movement control device 12 so that the vehicle 1 moves along the teacher path R1 based on the estimated current position of the vehicle 1 and positions on the teacher path R1 represented by the teacher path data 18A.

Here, while the vehicle 1 moves in autonomous traveling from the predetermined position P1 to the parking target position P2 along the teacher path R1, an object, which did not exist during teacher traveling, may be detected.

Therefore, in the embodiment, the controller 11 further executes the following processing in the autonomous traveling mode.

As described above, the controller 11 causes the movement control device 12 to control at least steering and causes the vehicle 1 to autonomously travel from the predetermined position P1 to the parking target position P2 based on the teacher path R1 and the second situation of the outside acquired by the sensor device 14.

In the case, the controller 11 causes the display device 22 to display a video of the outside of the vehicle 1. Furthermore, the controller 11 highlights, in the video on the display device 22, an object, which did not exist during teacher traveling, exists during autonomous traveling, and exists within a predetermined range from the teacher path R1.

The object within a predetermined range from the teacher path R1 is only required not to exist during teacher traveling, to exist during autonomous traveling, and to exist within a predetermined range from the teacher path R1. Specifically, the object within a predetermined range from the teacher path R1 did not exist during teacher traveling, exists during autonomous traveling, and overlaps a region through which the vehicle 1 passes when traveling on the teacher path R1 in the real space.

The controller 11 detects an object, which did not exist during teacher traveling and exists during autonomous traveling, based on the first situation and the second situation.

Specifically, the controller 11 identifies first feature points Q1 detected based on the first situation during teacher traveling by reading the first feature points Q1 registered in the map data 18B. Then, the controller 11 identifies a plurality of second feature points Q2 around the vehicle 1 at the current position of the vehicle 1 by analyzing sensor information representing the second situation detected by the sensor device 14 at the current position of the vehicle 1 in a manner similar to that described above.

Then, the controller 11 determines whether or not there is an object, which did not exist during teacher traveling, exists during autonomous traveling, and exists within a predetermined range from the teacher path R1, by using the difference between the feature points Q of the identified first feature points Q1 and the identified second feature points Q2. For example, the controller 11 identifies a group of second feature points Q2 that do not overlap the identified first feature points Q1 among the identified second feature points Q2. Then, it is determined whether or not at least a part of a region occupied by the object constituted by the group of the identified non-overlapping second feature points Q2 overlaps the region through which the vehicle 1 passes when traveling on the teacher path R1. When an affirmative determination is made in the determination, the controller 11 is required to determine that there is an object, which did not exist during teacher traveling, exists during autonomous traveling, and exists within a predetermined range from the teacher path R1.

The controller 11 highlights the identified object in the video on the display device 22.

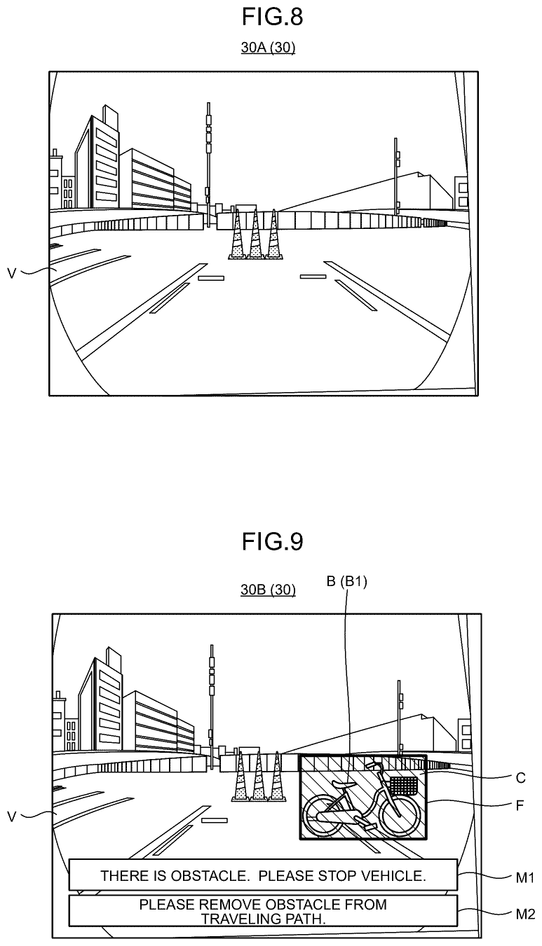

FIGS. 8 and 9 are schematic diagrams illustrating examples of a screen 30 displayed on the display device 22.

FIG. 8 is a schematic diagram of an example of a screen 30A displayed on the display device 22 at a certain point during teacher traveling. The screen 30A is an example of the screen 30. For example, during teacher traveling, the controller 11 causes the display device 22 to display the screen 30A including a video V captured by the camera 16.

FIG. 9 is a schematic diagram of an example of a screen 30B displayed on the display device 22 at the same point as that in FIG. 8 during autonomous traveling along the teacher path R1. The screen 30B is an example of the screen 30. For example, a scene is assumed in which the controller 11 determines that there is an object B, which did not exist during teacher traveling, at the same point as the point in FIG. 8 during autonomous traveling along the teacher path R1.

In this case, the controller 11 highlights the object B included in the video V at the point. FIG. 9 illustrates an example in which the controller 11 highlights the object B by superimposing a frame F surrounding a region having the object B included in the video V. Note that the frame F is only required to have a predetermined shape. The frame F may have, for example, a quadrangular shape, a circular shape, an elliptical shape, a triangular shape, and a star shape.

As described above, while the vehicle 1 autonomously travels along the teacher path R1, the controller 11 highlights, in the video V on the display device 22, the object B, which did not exist during teacher traveling, exists during autonomous traveling, and exists within a predetermined range from the teacher path R1. Therefore, the controller 11 can provide the presence of the object B to the passenger in a manner in which attention can be attracted. Furthermore, since selectively highlighting not all objects detected during autonomous traveling but the object B, which did not exist during teacher traveling and exists during autonomous traveling, the controller 11 can effectively provide the presence of the object B different from that during teacher traveling to the passenger in a manner in which attention can be attracted.

Furthermore, as illustrated in FIG. 9, the controller 11 may highlight the object in the video V by transparently superimposing an image C in a predetermined color on a region corresponding to the object B included in the video V. Transparently superimposing the image C means that the image C in a color having transmittance adjusted to be equal to or more than a predetermined transmittance is superimposed so that the region of the object B on which the image C is superimposed in the video V can be visually recognized. The image C preferably has a color that can call attention to the passenger. Examples of the color of the image include red and yellow, these are not limitations. Furthermore, the image C may be represented in two or more colors. For example, the image C may be represented by two or more colors such as yellow and a transparent color, yellow and black, and yellow and gray.

Furthermore, the controller 11 may highlight, in the video V, the object B included in the video V, and further display at least one of first display M1 and second display M2.

The first display M1 prompts a stop operation on the vehicle 1. In an example, FIG. 9 illustrates, in an example, a mode in which the first display M1 is words prompting a stop operation on the vehicle 1. The first display M1 may be a still image, an animation image, an icon, or the like that prompts a stop operation on the vehicle 1. The first display M1 is not limited to words.

The second display M2 prompts removal of the object B. In an example, FIG. 9 illustrates, in an example, a mode in which the second display M2 is words prompting removal of the object B. The second display M2 may be a still image, an animation image, an icon, or the like that prompts removal of the object B. The second display M2 is not limited to words.

When the object B, which did not exist during teacher traveling, exists during autonomous traveling, and exists within a predetermined range from the teacher path R1, is detected during autonomous traveling of the vehicle 1 along the teacher path R1, the controller 11 further displays at least one of the first display M1 and the second display M2. This can inhibit the occurrence of an obstacle in traveling of the vehicle 1 due to the presence of the object B.

Note that the controller 11 may highlight, in the video V, the object B included in the video V, superimpose and display the first display M1 on the video V, and then superimpose and display the second display M2 on the video V. The first display M1 and the second display M2 are not limited to being displayed at the same timing.

Next, an example of a flow of information processing executed by the controller 11 of the vehicle control device 10 will be described.

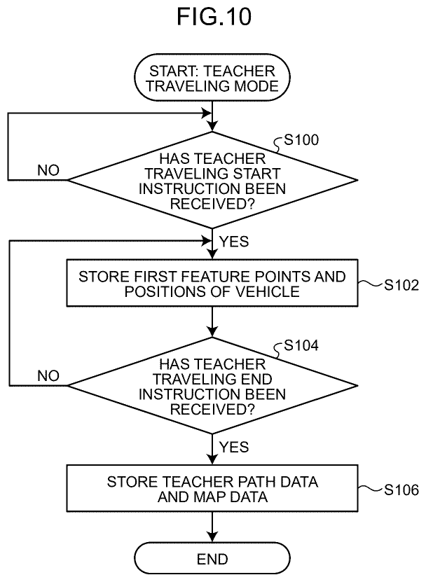

FIG. 10 is a flowchart illustrating the example of the flow of information processing executed by the controller 11 in the teacher traveling mode.

The controller 11 determines whether or not a teacher traveling start instruction has been received from the operation device 20 (Step S100). The controller 11 repeats a negative determination (Step S100: No) until an affirmative determination is made in Step S100 (Step S100: Yes). When the controller 11 makes an affirmative determination in Step S100 (Step S100: Yes), the processing proceeds to Step S102.

When teacher traveling of the vehicle 1 is started by a driving operation on the vehicle 1 of a user, the controller 11 sequentially stores the first feature points Q1 and the current positions of the vehicle 1 in the storage device 18 (Step S102). Specifically, the controller 11 sequentially stores the current positions of the vehicle 1 sequentially estimated along the teacher traveling of the vehicle 1. In the case, the controller 11 gives INDEX to each of the current positions, and sequentially stores traveling positions, which are the current positions, azimuths, traveling directions, and pieces of reference traveling information in association with each other. Furthermore, the controller 11 identifies the first feature points Q1 by performing image analysis on a video captured by the camera 16 during teacher traveling, and sequentially registers the first feature points Q1 in the map data 18B.

The controller 11 determines whether or not a teacher traveling end instruction has been received from the operation device 20 (Step S104). The controller 11 makes the determination in Step S104 by determining whether or not a signal representing the end instruction has been received from the operation device 20 by the operation of the operation device 20 by the passenger. When a negative determination is made in Step S104 (Step S104: No), the controller 11 returns to Step S102. When the controller 11 makes an affirmative determination in Step S104 (Step S104: Yes), the processing proceeds to Step S106.

In Step S106, the controller 11 stores the teacher path data 18A and the map data 18B in the storage device 18 (Step S106). The controller 11 sets, as the teacher path R1, the traveling path R during teacher traveling represented by a group of the sequentially estimated current positions stored by the processing of Step S102, and stores the teacher path data 18A representing the teacher path R1 in the storage device 18. Furthermore, the controller 11 stores the map data 18B, in which the first feature points Q1 identified by the processing of Step S102 are registered, in the storage device 18. Then, the routine is ended.

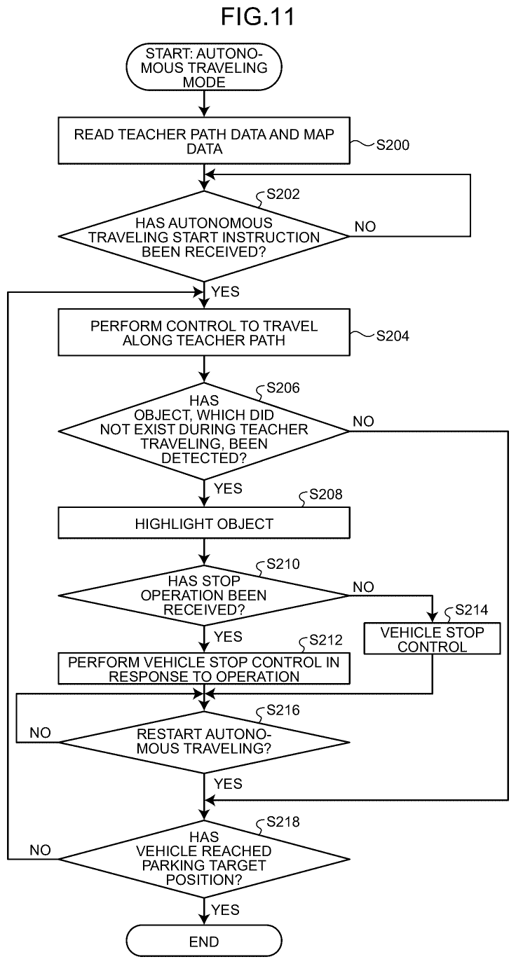

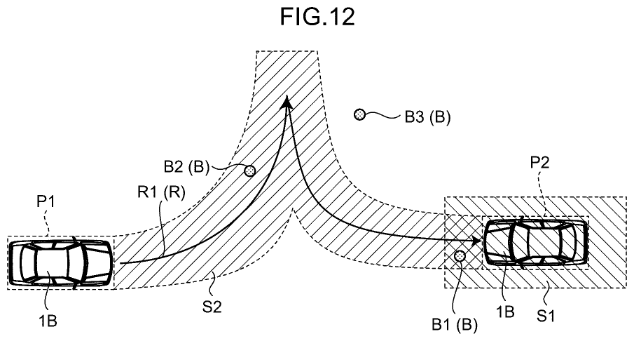

FIG. 11 is a flowchart illustrating an example of the flow of information processing executed by the controller 11 in the autonomous traveling mode. When receiving a signal representing an instruction to switch to the autonomous traveling mode from the operation device 20, the controller 11 switches the traveling mode to the autonomous traveling mode, and executes the information processing in FIG. 11.

The controller 11 reads the teacher path data 18A and the map data 18B from the storage device 18 (Step S200). Then, the controller 11 determines whether or not an autonomous traveling start instruction has been received from the operation device 20 (Step S202). The controller 11 repeats a negative determination (Step S202: No) until an affirmative determination is made in Step S202 (Step S202: Yes). When the controller 11 makes an affirmative determination in Step S202 (Step S202: Yes), the processing proceeds to Step S204.

The controller 11 controls the movement control device 12 so that autonomous traveling is performed along the teacher path R1 represented by the teacher path data 18A read in Step S200 (Step S204). That is, the controller 11 causes the vehicle 1 to autonomously travel from the predetermined position P1 toward the parking target position P2 along the teacher path R1 by controlling the movement control device 12 so that the current position of the vehicle 1 included in the sensor information, which is the second situation acquired from the sensor device 14, is provided on the teacher path R1 represented by the teacher path data 18A.

The controller 11 determines whether or not the object B, which did not exist during teacher traveling, has been detected (Step S206). As described above, the controller 11 makes a determination in Step S206 by determining whether or not there is an object, which did not exist during teacher traveling, exists during autonomous traveling, and exists within a predetermined range from the teacher path R1, by using the difference between the feature points Q of the first feature points Q1 and the second feature points Q2. When an affirmative determination is made in Step S206 (Step S206: Yes), the processing proceeds to Step S208.

In Step S208, the controller 11 highlights the object B detected in Step S206 in the video V on the display device 22 (Step S208). In the case, the controller 11 may further display at least one of the first display M1 and the second display M2 in the video V.

Next, the controller 11 determines whether or not a stop operation for stopping the vehicle 1 has been received by an operation of the operation device 20 performed by the passenger (Step S210).

When an affirmative determination is made in Step S210 (Step S210: Yes), the processing proceeds to Step S212. In Step S212, the controller 11 controls the movement control device 12 to stop the vehicle 1 in response to the stop operation received in Step S210. Then, the processing proceeds to Step S216. When a negative determination is made in Step S210 (Step S210: No), the processing proceeds to Step S214. In Step S214, the controller 11 controls the movement control device 12 to stop the vehicle 1 (Step S214). Then, the processing proceeds to Step S216.

In Step S216, the controller 11 determines whether or not to restart the autonomous traveling along the teacher path R1 (Step S216). For example, when a restart instruction signal representing restart of autonomous traveling is input by an instruction regarding an operation of the operation device 20 from the passenger, the controller 11 makes the determination in Step S216 by determining whether or not the restart instruction signal has been received. The controller 11 repeats a negative determination (Step S216: No) until an affirmative determination is made in Step S216 (Step S216: Yes). When an affirmative determination is made in Step S216 (Step S216: Yes), the processing proceeds to Step S218.

In Step S218, the controller 11 determines whether or not the vehicle 1 has reached the parking target position P2 (Step S218). When a negative determination is made in Step S218 (Step S218: No), the processing returns to Step S204 above. When an affirmative determination is made in Step S218 (Step S218: Yes), the routine is ended.

In contrast, when a negative determination is made in Step S206 above (Step S206: No), the processing proceeds to Step S218. That is, when the sensor device 14 does not detect the object B, which did not exist during teacher traveling, exists during autonomous traveling, and exists within a predetermined range from the teacher path R1 (Step S206: No), the controller 11 causes the movement control device 12 to control at least steering and causes the vehicle 1 to autonomously travel to the parking target position P2 based on the teacher path R1 and the third situation of the outside acquired by the sensor device 14.

As described above, the vehicle control device 10 of the embodiment is mounted on the vehicle 1 including the operation device 20, the sensor device 14, the display device 22, and the movement control device 12. The operation device 20 receives an operation of the passenger. The sensor device 14 acquires a situation of the outside including a video of the outside of the vehicle 1. The passenger can visually recognize the display device 22. The movement control device 12 controls at least steering. In response to the operation device 20 receiving an operation of the passenger, the vehicle control device 10 registers the teacher path R1 based on the first situation of the outside acquired by the sensor device 14 while the vehicle 1 performs teacher traveling from the predetermined position P1 to the parking target position P2. Based on the teacher path R1 and the second situation of the outside acquired by the sensor device 14, the vehicle control device 10 causes the movement control device 12 to control at least steering to cause the vehicle 1 to autonomously travel from the predetermined position P1 to the parking target position P2, and causes the display device 22 to display the video V of the outside of the vehicle 1. Furthermore, when the sensor device 14 detects the object B, which does not exist during teacher traveling, exists during autonomous traveling, and exists within a predetermined range from the teacher path R1, the vehicle control device 10 highlights the object B in the video V on the display device 22, and causes the display device 22 to display the first display M1 prompting a stop operation on the vehicle 1. Furthermore, when the sensor device 14 does not detect the object B, which does not exist during teacher traveling, exists during autonomous traveling, and exists within a predetermined range from the teacher path R1, the vehicle control device 10 causes the movement control device 12 to control at least steering and causes the vehicle 1 to autonomously travel to the parking target position P2 based on the teacher path R1 and the third situation of the outside acquired by the sensor device 14.

Here, there may be the object B, which did not exist during teacher traveling, during autonomous traveling along the teacher path R1. In such a case, conventional techniques may have difficulty in automated parking by autonomous traveling. That is, the conventional techniques may have difficulty in providing preferred parking assistance.

In contrast, when the vehicle 1 autonomously travels along the teacher path R1, the vehicle control device 10 of the embodiment highlights, in the video V on the display device 22, the object B, which does not exist during teacher traveling, exists during autonomous traveling, and exists within a predetermined range from the teacher path R1, and causes the display device 22 to display the first display M1 prompting a stop operation on the vehicle 1. Therefore, the vehicle control device 10 of the embodiment can provide the presence of the object B to the passenger in a manner in which attention can be attracted. Furthermore, since selectively highlighting not all objects detected during autonomous traveling but the object B, which did not exist during teacher traveling and exists during autonomous traveling, the controller 11 can effectively provide the presence of the object B different from that during teacher traveling to the passenger in a manner in which attention can be attracted. Furthermore, the vehicle control device 10 of the embodiment highlights, in the video V on the display device 22, the object B, which exists within a predetermined range from the teacher path R1, and causes the display device 22 to display the first display M1 prompting a stop operation on the vehicle 1. Therefore, assistance can be provided so that contact of the vehicle 1 against the object B is avoided.

Therefore, the vehicle control device 10 of the embodiment can provide more preferred parking assistance.

### Second Embodiment

In an embodiment, more detailed parking assistance in accordance with the position of an object B, which did not exist during teacher traveling and exists during autonomous traveling, will be described.

FIG. 1 is a block diagram illustrating an example of an overall configuration of a vehicle 1B of the embodiment.

The vehicle 1B includes a vehicle control device 10B, a movement control device 12, a sensor device 14, a storage device 18, an operation device 20, and a display device 22. The movement control device 12, the sensor device 14, the storage device 18, the operation device 20, and the display device 22 are connected to the vehicle control device 10B so as to be able to transfer data or signals.

The vehicle 1B is similar to the vehicle 1 of the above-described embodiment except that the vehicle control device 10B is provided instead of the vehicle control device 10. Furthermore, the sensor device 14, the camera 16, the appearance of the vehicle 1B, and the configuration in the vicinity of a driver seat 24A of the vehicle 1B are also similar to those of the above-described vehicle 1 (see FIGS. 2 to 4).

Similarly to the vehicle control device 10, the vehicle control device 10B is an electronic control unit that integrally controls each unit of the vehicle 1B. The vehicle control device 10B is similar to the vehicle control device 10 of the above-described embodiment except that a controller 11B is provided instead of the controller 11.

The controller 11B integrally controls each unit of the vehicle 1B.

Similarly to the controller 11 of the above-described embodiment, the controller 11B can switch a traveling mode to a teacher traveling mode or an autonomous traveling mode based on, for example, an input operation on the operation device 20 performed by a passenger.

Furthermore, similarly to the controller 11 of the above-described embodiment, in response to the operation device 20 receiving an operation of the passenger, the controller 11B registers a teacher path R1 and the map data 18B based on the first situation of the outside acquired by the sensor device 14 while the vehicle 1B performs teacher traveling from the predetermined position P1 to the parking target position P2. Furthermore, similarly to the controller 11 of the above-described embodiment, based on the teacher path R1 and a second situation of the outside acquired by the sensor device 14, the controller 11B causes the movement control device 12 to control at least steering to cause the vehicle 1B to autonomously travel from the predetermined position P1 to the parking target position P2, and causes the display device 22 to display a video V of the outside of the vehicle 1. As in the above-described embodiment, while the vehicle 1B moves in autonomous traveling from the predetermined position P1 to the parking target position P2 along the teacher path R1, the object B, which did not exist during teacher traveling, may be detected.

In the embodiment, the controller 11B further executes the following processing in the autonomous traveling mode.

FIG. 12 is an explanatory diagram of an example of parking assistance given by the controller 11B of the embodiment.

FIG. 12 illustrates a scene in which the controller 11B causes the movement control device 12 to control at least steering and causes the vehicle 1 to autonomously travel from the predetermined position P1 to the parking target position P2 based on the teacher path R1 and the second situation of the outside acquired by the sensor device 14.

Similarly to the controller 11 of the above-described embodiment, the controller 11B causes the display device 22 to display the video V of the outside of the vehicle 1. Furthermore, similarly to the controller 11 of the above-described embodiment, when the sensor device 14 detects a first object B1, which did not exist during teacher traveling and exists during autonomous traveling, the controller 11B highlights the first object B1 in the video V on the display device 22, and causes the display device 22 to display the second display M2 prompting removal of the object B.

The first object B1 is the object B, which did not exist during teacher traveling and exists during autonomous traveling. The first object B1 is the object B, which exists within a first range S1 from the parking target position P2 and exists within a second range S2 from the teacher path R1. The first object B1 is an example of the object B.

The first range S1 is a region of a predetermined range including the parking target position P2. Specifically, the first range S1 is a region where the vehicle 1B having difficulty in avoiding the object B and continuing traveling. The vehicle 1B has autonomously traveled toward the parking target position P2 along the teacher path R1, and reached the vicinity of the parking target position P2 or the parking target position P2. In the embodiment, a mode will be described in an example in which the first range S1 is a region in a rectangular region obtained by enlarging a rectangular frame surrounding the vehicle 1 along the outer shape of the vehicle 1 parked at the parking target position P2 to the front side, the rear side, the left side, and the right side of the vehicle 1 by a predetermined distance.

The second range S2 is a region through which the vehicle 1B passes when traveling on the teacher path R1 in real space.

As in the above-described embodiment, the controller 11B detects the object B, which did not exist during teacher traveling and exists during autonomous traveling, based on the first situation and the second situation. Furthermore, the vehicle 1B may detect which of the first range S1, the second range S2, a range where the first range S1 and the second range S2 overlap each other, and the outside of the range of the first range S1 and the second range S2 the object B exists in by analyzing the second situation including sensor information acquired by the sensor device 14 by a known method.

When the first object B1 is detected, the controller 11B highlights the first object B1 in the video V on the display device 22, and causes the display device 22 to display the second display M2 prompting removal of the object B. The first object B1 is the object B, which did not exist during teacher traveling, exists during autonomous traveling, and exists within the first range S1. Furthermore, when the first object B1 is detected, the controller 11B may control the movement control device 12 to autonomously stop the vehicle 1B. The first object B1 is the object B, which did not exist during teacher traveling, exists during autonomous traveling, and exists within the first range S1.

When the first object B1 is detected, the controller 11B may cause the display device 22 to further display first display M1 prompting a stop operation on the vehicle 1B. The first object B1 is the object B, which did not exist during teacher traveling, exists during autonomous traveling, and exists within the first range S1.

That is, when the first object B1 is detected, the controller 11B causes the display device 22 to display a screen 30B in FIG. 9. The first object B1 is the object B, which did not exist during teacher traveling, exists during autonomous traveling, and exists within the first range S1.

When the first object B1 is detected within the first range S1, the controller 11B may highlight the first object B1 in the video V on the display device 22 in a first mode. The first object B1 is the object B, which did not exist during teacher traveling and exists during autonomous traveling. The first mode is only required to be a predetermined display mode for highlighting.

As described in the above-described embodiment, examples of the display mode for highlighting include superimposing and displaying a frame F having a specific shape surrounding a region having the object B and transparently superimposing and displaying an image C in a predetermined color on a region corresponding to the object B included in the video V.

Returning to FIG. 12, the description will be continued.

When the sensor device 14 detects a second object B2, which did not exist during teacher traveling and exists during autonomous traveling, the controller 11B at least does not cause the display device 22 to display the second display M2 prompting removal of the object B.

The second object B2 is the object B, which did not exist during teacher traveling and exists during autonomous traveling. The second object B2 exists outside a first range S1 and exists within a second range S2 from the teacher path R1. The second object B2 is an example of the object B.

When the second object B2 is detected, the controller 11B highlights the second object B2 in the video V on the display device 22. The second object B2 is the object B, which did not exist during teacher traveling, exists during autonomous traveling, exists outside the first range S1, and exists within the second range S2. In this case, however, the controller 11B does not cause the display device 22 to display the second display M2 prompting removal of the object B.

When the second object B2 is detected, the controller 11B may highlight the second object B2 in the video V on the display device 22 in a second mode. The second object B2 is the object B, which did not exist during teacher traveling, exists during autonomous traveling, exists outside the first range S1, and exists within the second range S2. The second mode is only required to be a predetermined display mode for highlighting.

Note that a first emphasis degree in the above-described first mode may be the same as or different from a second emphasis degree in the second mode. The first emphasis degree is the degree of emphasis of the object B displayed in the first mode. The second emphasis degree is the degree of emphasis of the object B displayed in the second mode. When the first emphasis degree in the first mode is different from the second emphasis degree in the second mode, the first emphasis degree in the first mode is preferably larger than the second emphasis degree in the second mode.

When the second object B2 is detected, the controller 11B causes the movement control device 12 to control at least steering and causes the vehicle 1B to autonomously travel toward the parking target position P2 while avoiding the second object B2. The second object B2 is the object B, which did not exist during teacher traveling, exists during autonomous traveling, exists outside the first range S1, and exists within the second range S2.

Specifically, when the second object B2 is detected, the controller 11B generates an avoidance path for autonomously traveling while avoiding the second object B2.

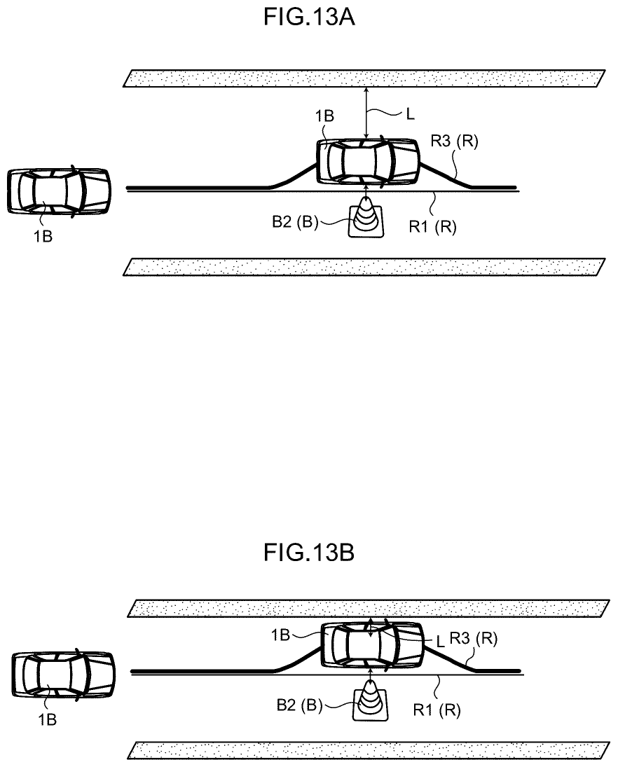

FIGS. 13A and 13B are explanatory diagrams of an example of an avoidance path R3.

For example, the controller 11B generates the avoidance path R3 for the vehicle 1B to avoid the second object B2 by a known method based on the second situation. Then, the controller 11B determines whether or not the generation of the avoidance path R3 has succeeded. When the generated avoidance path R3 is the traveling path R on which the vehicle 1B can travel without deviating from a traveling road on which the vehicle 1B is traveling (see FIG. 13A), the controller 11B determines that the generation of the avoidance path R3 has succeeded. When the generated avoidance path R3 is the traveling path R on which the vehicle 1B deviates from the traveling road on which the vehicle 1B is traveling or the traveling path R on which the vehicle 1B may contact another object and the like (see FIG. 13B), the controller 11B determines that the generation of the avoidance path R3 has failed. Specifically, for example, when the vehicle 1B may contact the object B or another object other than the object B in a case where the vehicle 1B travels along the generated avoidance path R3 or when a shortest distance L from the other object is less than a predetermined distance, the controller 11B determines that the generation of the avoidance path R3 has failed.

Then, when determining that the generation of the avoidance path R3 has succeeded, the controller 11B updates teacher path data of the teacher path R1 with avoidance path data of the generated avoidance path R3, and controls the movement control device 12 so that autonomous traveling is performed along the teacher path R1 represented by the updated teacher path data.

Returning to FIG. 12, the description will be continued.

When the sensor device 14 detects a third object B3, which did not exist during teacher traveling and exists during autonomous traveling, the controller 11B at least does not display the second display M2 prompting the display device 22 to remove the object B.

The third object B3 is the object B, which did not exist during teacher traveling and exists during autonomous traveling. The third object B3 is the object, which exists outside the first range S1 from the parking target position P2 and exists outside the second range S2 from the teacher path R1. The third object B3 is an example of the object B.

Therefore, in the embodiment, when the second object B2 is detected within the second range S2 from the teacher path R1 at the time when the vehicle 1B autonomously travels from the predetermined position P1 to the parking target position P2, the controller 11B highlights the second object B2 in the second mode, generates the avoidance path R3 for avoiding the second object B2, and continues autonomous traveling along the avoidance path R3. Furthermore, when third object B3 is detected outside the second range S2 from the teacher path R1 and outside the first range S1 from the parking target position P2 at the time when the vehicle 1B autonomously travels from the predetermined position P1 to the parking target position P2, the controller 11B does not display the first display M1 and the second display M2, and continues autonomous traveling along the teacher path R1. Furthermore, when the first object B1 is detected within the second range S2 from the teacher path R1 and within the first range S1 from the parking target position P2 at the time when the vehicle 1B autonomously travels from the predetermined position P1 to the parking target position P2, the controller 11B highlights the first object B1 in the first mode, and displays the first display M1 and the second display M2 on the display device 22.

Therefore, the controller 11B of the embodiment can provide preferred parking assistance.

Next, an example of a flow of information processing executed by the controller 11B of the vehicle control device 10B of the embodiment will be described.

The flow of the information processing executed by the controller 11B in the teacher traveling mode is similar to the flowchart in FIG. 10 described in the above-described embodiment.

A flow of information processing executed by the controller 11B in the autonomous traveling mode will be described.

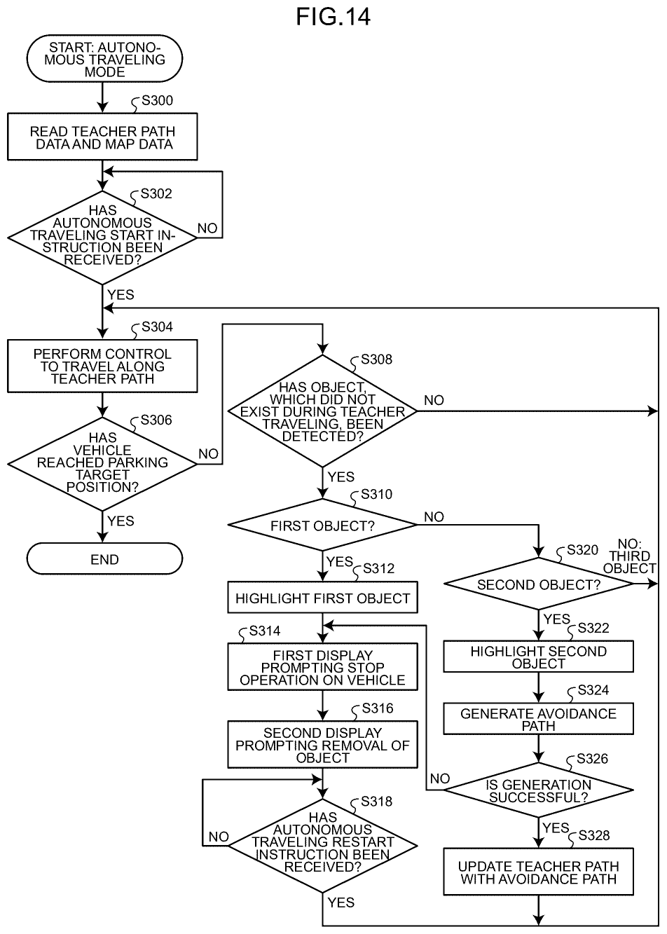

FIG. 14 is a flowchart illustrating an example of the flow of information processing executed by the controller 11B in the autonomous traveling mode.

When receiving a signal representing an instruction to switch to the autonomous traveling mode from the operation device 20, the controller 11B switches the traveling mode to the autonomous traveling mode, and executes the information processing in FIG. 14.

The controller 11B reads the teacher path data 18A and the map data 18B from the storage device 18 (Step S300). Then, the controller 11B determines whether or not an autonomous traveling start instruction has been received from the operation device 20 (Step S302). The controller 11B repeats a negative determination (Step S302: No) until an affirmative determination is made in Step S302 (Step S302: Yes). When the controller 11B makes an affirmative determination in Step S302 (Step S302: Yes), the processing proceeds to Step S304.

In Step S304, the controller 11B controls the movement control device 12 so that autonomous traveling is performed along the teacher path R1 represented by the teacher path data 18A or the teacher path R1 updated in Step S328 to be described later (Step S304). That is, the controller 11 causes the vehicle 1B to autonomously travel from the predetermined position P1 toward the parking target position P2 along the teacher path R1 by controlling the movement control device 12 so that the current position of the vehicle 1B included in the sensor information, which is the second situation acquired from the sensor device 14, is provided on the teacher path R1.

Next, the controller 11B determines whether or not the vehicle 1B has reached the parking target position P2 (Step S306). When an affirmative determination is made in Step S306 (Step S306: Yes), the routine is ended. When a negative determination is made in Step S306 (Step S306: No), the processing proceeds to Step S308.

Note that, when a negative determination is made in Step S306 (Step S306: No), whether the self-position of the vehicle 1B is located in a specific distance from the parking target position P2 may be determined. The position in a specific distance from the parking target position P2 is located outside the first range S1, and is only required to be located on a side closer to the parking target position P2 than to the predetermined position P1 on the teacher path R1. Then, when the self-position of the vehicle 1B is determined to be located in the specific distance from the parking target position P2, the processing may proceed to Step S308.

In Step S308, the controller 11B determines whether or not the object B, which did not exist during teacher traveling, has been detected (Step S308). The controller 11B makes a determination in Step S308 by determining whether or not there is the object B, which did not exist during teacher traveling and exists during autonomous traveling, by using the difference between the feature points Q of the first feature points Q1 and the second feature points Q2. When a negative determination is made in Step S308 (Step S308: No), the processing returns to Step S304 above.

When an affirmative determination is made in Step S308 (Step S308: Yes), the processing proceeds to Step S310.

In Step S310, the controller 11B determines whether or not the object B detected in Step S308 is the first object B1 (Step S310). The controller 11B determines whether or not the object B detected in Step S308 is the first object B1 by determining whether or not the object B detected in Step S308 is within the first range S1 from the parking target position P2 and within the second range S2 from the teacher path R1.

When the object B is determined to be the first object B1 in Step S310 (Step S310: Yes), the processing proceeds to Step S312.

In Step S312, the controller 11B highlights the first object B1, which is the object B detected in Step S308, in the video V on the display device 22 (Step S312). Furthermore, the controller 11B displays, in the video V, the first display M1 prompting a stop operation on the vehicle 1B (Step S314). Furthermore, the controller 11B displays, in the video V, the second display M2 prompting removal of the object B (Step S316).

Then, the controller 11B determines whether or not an autonomous traveling restart instruction has been received by an operation on the operation device 20 performed by the passenger (Step S318). The controller 11B repeats a negative determination (Step S318: No) until an affirmative determination is made in Step S318 (Step S318: Yes). Note that, in the case, the controller 11B may detect opening and closing of a door of the vehicle 1B, and cause the display device 22 to further give display prompting confirmation of whether or not the object B has been removed. When a signal representing removal completion is received by an operation on the operation device 20 performed by the passenger on the display, the controller 11B may make an affirmative determination in Step S318.

When an affirmative determination is made in Step S318 (Step S318: Yes), the processing proceeds to Step S304 above.

In contrast, when the object B is determined not to be the first object B1 in Step S310 (Step S310: No), the processing proceeds to Step S320.

In Step S320, the controller 11B determines whether or not the object B detected in Step S308 is the second object B2 (Step S320). The controller 11B determines whether or not the object B detected in Step S308 is the second object B2 by determining whether or not the object B detected in Step S308 is outside the first range S1 from the parking target position P2 and within the second range S2 from the teacher path R1.

When the object B is determined to be the second object B2 in Step S320 (Step S320: Yes), the processing proceeds to Step S322.

In Step S322, the controller 11B highlights the second object B2, which is the object B detected in Step S308, in the video V on the display device 22 (Step S322).

Then, the controller 11B generates the avoidance path R3 for autonomously traveling while avoiding the second object B2 (Step S324). When the controller 11B fails to generate the avoidance path R3 (Step S326: No), the processing proceeds to Step S314 above. When the controller 11B succeeds in generating the avoidance path R3 (Step S326: Yes), the processing proceeds to Step S328.

In Step S328, the controller 11B updates the teacher path R1 of the teacher path data 18A read in Step S300 with the avoidance path R3 generated in Step S324 (Step S328), and the processing proceeds to Step S304 above.

In contrast, when making a negative determination in Step S320 (Step S320: No), the controller 11B determines that the object B detected in Step S308 is the third object B3, and the processing proceeds to Step S304 above.

As described above, the vehicle control device 10B of the embodiment is mounted on the vehicle 1B including the operation device 20, the sensor device 14, the display device 22, and the movement control device 12. The operation device 20 receives an operation of the passenger. The sensor device 14 acquires a situation of the outside including a video of the outside of the vehicle 1B. The passenger can visually recognize the display device 22. The movement control device 12 controls at least steering. In response to the operation device 20 receiving an operation of the passenger, the vehicle control device 10B registers the teacher path R1 based on the first situation of the outside acquired by the sensor device 14 while the vehicle 1B performs teacher traveling from the predetermined position P1 to the parking target position P2. Based on the teacher path R1 and the second situation of the outside acquired by the sensor device 14, the vehicle control device 10B causes the movement control device 12 to control at least steering to cause the vehicle 1 to autonomously travel from the predetermined position P1 to the parking target position P2, and causes the display device 22 to display the video V of the outside of the vehicle 1. Furthermore, when the sensor device 14 detects the first object B1, the vehicle control device 10B highlights the first object B1 in the video V on the display device 22, and causes the display device 22 to display the second display M2 prompting removal of the object B. The first object B1 is the object B, which did not exist during teacher traveling and exists during autonomous traveling. The first object B1 exists within the first range S1 from the parking target position P2, and exists within the second range S2 from the teacher path R1. Furthermore, when the sensor device 14 detects the second object B2, the vehicle control device 10B at least does not cause the display device 22 to display the second display M2 prompting removal of the object B. The second object B2 did not exist during teacher traveling and exists during autonomous traveling. The second object B2 exists outside the first range S1 from the parking target position P2, and exists within the second range S2 from the teacher path R1.

There may be the object B, which did not exist during teacher traveling, during autonomous traveling along the teacher path R1. In such a case, conventional techniques may have difficulty in automated parking by autonomous traveling. That is, the conventional techniques may have difficulty in providing preferred parking assistance.

In contrast, during autonomous traveling along the teacher path R1 of the vehicle 1, the vehicle control device 10B of the embodiment gives display such as highlighting of the object B, the first display M1, and the second display M2 in accordance with the position of the object B, which did not exist during teacher traveling and exists during autonomous traveling, to at least one of the teacher path R1 and the parking target position P2. Therefore, the vehicle control device 10B of the embodiment can provide the presence of the object B to the passenger in a manner in which attention can be attracted in accordance with the position of the object B.

Therefore, the vehicle control device 10B of the embodiment can provide more preferred parking assistance.

Next, a hardware configuration of the vehicle control device 10 and the vehicle control device 10B of the embodiment described above will be described.

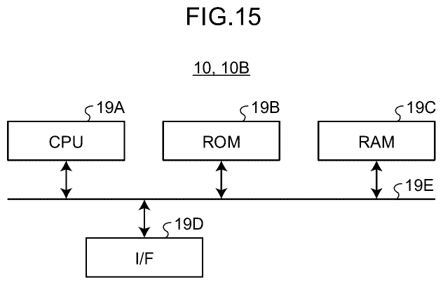

FIG. 15 is a block diagram illustrating an example of the hardware configuration of the vehicle control device 10 and the vehicle control device 10B of the embodiment described above.

The vehicle control device 10 and the vehicle control device 10B have a hardware configuration using a normal computer, in which a central processing unit (CPU) 19A, a read only memory (ROM) 19B, a random access memory (RAM) 19C, an I/F 19D, and the like are mutually connected by a bus 19E. The I/F 19D are used for connection to various devices.

The CPU 19A is an arithmetic device that controls the overall processing of the vehicle control device 10 and the vehicle control device 10B. The RAM 19C stores data necessary for various types of processing performed by the CPU 19A. The ROM 19B stores, for example, programs for performing various types of processing performed by the CPU 19A. The I/F 19D is connected to an external device or an external terminal via a communication line or the like. The I/F 11D is an interface used for transmission and reception of data to and from the external device or the external terminal to which the connection is performed.

A program for executing the above-described various types of processing to be executed by the vehicle control device 10 and the vehicle control device 10B is provided by being preliminarily incorporated in the ROM 19B or the like. A program for executing the vehicle control method to be executed in the embodiment may be provided to these devices by being recorded in a computer-readable recording medium such as a CD-ROM, a flexible disk (FD), a CD-R, and a digital versatile disc (DVD) in a file in an installable format or an executable format.

Furthermore, the program for executing the vehicle control method to be executed in the embodiment may be provided by being stored in a computer connected to a network such as the Internet and downloaded via the network. Furthermore, the program for executing the vehicle control method to be executed in the embodiment may be provided or distributed via the network such as the Internet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method to be executed by a vehicle control device mounted in a vehicle including: an operation device that receives an operation of a passenger; a sensor device that acquires a situation of an outside including a video of the outside of the vehicle; a display device that is allowed to be visually recognized by the passenger; and a movement control device that controls at least steering, the method comprising:
in response to the operation device receiving the operation of the passenger, registering a teacher path based on a first situation of the outside acquired by the sensor device while the vehicle performs teacher traveling from a predetermined position to a parking target position;
based on the teacher path and a second situation of the outside acquired by the sensor device, causing the movement control device to control at least steering to cause the vehicle to autonomously travel from the predetermined position toward the parking target position and causing the display device to display the video of the outside of the vehicle;
when the sensor device detects an object, which does not exist during the teacher traveling, exists during autonomous traveling, and exists within a predetermined range from the teacher path, highlighting the object in the video on the display device and causing the display device to display first display prompting a stop operation of the vehicle;
based on the teacher path and a third situation of the outside acquired by the sensor device, causing the movement control device to control at least steering to cause the vehicle to autonomously travel from the predetermined position toward the parking target position, and causing the display device to display the video of the outside of the vehicle; and
when the sensor device does not detect the object, which does not exist during the teacher traveling, exists during the autonomous traveling, and exists within the predetermined range from the teacher path, causing the movement control device to control at least steering to cause the vehicle to autonomously travel to the parking target position based on the teacher path and the third situation of the outside acquired by the sensor device.

2. The vehicle control method according to claim 1, further comprising:
causing the display device to display a word prompting the stop operation of the vehicle as the first display, and causing the display device to display second display prompting removal of the object along with displaying the first display or after displaying the first display.

3. The vehicle control method according to claim 1, wherein
the object, which does not exist during the teacher traveling and exists during the autonomous traveling, is detected based on the first situation and the second situation.

4. The vehicle control method according to claim 1, wherein
the sensor device includes a camera arranged in the vehicle.

5. The vehicle control method according to claim 4, wherein
the camera includes at least a first camera, a second camera, a third camera, and a fourth camera,
the first camera is arranged in a front portion of the vehicle,
the second camera is arranged in a right portion of the vehicle,
the third camera is arranged in a left portion of the vehicle, and
the fourth camera is arranged in a rear portion of the vehicle.

6. The vehicle control method according to claim 1, wherein
the sensor device further includes at least one of a radar, a LiDAR, and a sonar.

7. The vehicle control method according to claim 1, wherein
the object, which exists within the predetermined range from the teacher path, includes an object that overlaps a region through which the vehicle passes when traveling on the teacher path in real space.

8. The vehicle control method according to claim 1, further comprising:
highlighting the object, which exists within the predetermined range from the teacher path, in the video on the display device by superimposing, on the video, a frame having a predetermined shape to the object that exists within the predetermined range from the teacher path.

9. The vehicle control method according to claim 1, further comprising:
highlighting the object, which exists within the predetermined range from the teacher path, in the video on the display device by transparently superimposing a predetermined color on a region corresponding to the object, which exists within the predetermined range from the teacher path, included in the video.

10. A vehicle control method to be executed by a vehicle control device mounted in a vehicle including: an operation device that receives an operation of a passenger; a sensor device that acquires a situation of an outside including a video of the outside of the vehicle; a display device that is allowed to be visually recognized by the passenger; and a movement control device that controls at least steering, the method comprising:
in response to the operation device receiving the operation of the passenger, registering a teacher path based on a first situation of the outside acquired by the sensor device while the vehicle performs teacher traveling from a predetermined position to a parking target position;
based on the teacher path and a second situation of the outside acquired by the sensor device, causing the movement control device to control at least steering to cause the vehicle to autonomously travel from the predetermined position toward the parking target position, and causing the display device to display the video of the outside of the vehicle;
when the sensor device detects a first object, which does not exist during the teacher traveling, exists during autonomous traveling, exists within a first range from the parking target position, and exists within a second range from the teacher path, highlighting the first object in the video on the display device and causing the display device to display second display prompting removal of the object; and
when the sensor device detects a second object, which does not exist during the teacher traveling, exists during the autonomous traveling, exists outside the first range from the parking target position, and exists within the second range from the teacher path, at least causing the display device not to display the second display prompting removal of the object.

11. The vehicle control method according to claim 10, further comprising:
when the sensor device detects the second object, which does not exist during the teacher traveling, exists during the autonomous traveling, exists outside the first range from the parking target position, and exists within the second range from the teacher path, causing the movement control device to control at least steering and causing the vehicle to autonomously travel toward the parking target position while avoiding the second object.

12. The vehicle control method according to claim 11, further comprising:
when the sensor device detects the first object, which does not exist during the teacher traveling, exists during the autonomous traveling, exists within the first range from the parking target position, and exists within the second range from the teacher path, highlighting the first object in the video on the display device, causing the display device to display first display prompting a stop operation of the vehicle, and causing the display device to display the second display prompting removal of the object.

13. The vehicle control method according to claim 11, further comprising:
when the sensor device detects a third object, which does not exist during the teacher traveling, exists during the autonomous traveling, exists outside the first range from the parking target position, and exists outside the second range from the teacher path, at least causing the display device not to display the second display prompting removal of the object.

14. The vehicle control method according to claim 11, further comprising:
when the sensor device detects the first object, which does not exist during the teacher traveling, exists during the autonomous traveling, exists within the first range from the parking target position, and exists within the second range from the teacher path, highlighting the first object in the video on the display device in a first mode and causing the display device to display the second display prompting removal of the object; and
when the sensor device detects the second object, which does not exist during the teacher traveling, exists during the autonomous traveling, exists outside the first range from the parking target position, and exists within the second range from the teacher path, highlighting the second object in the video on the display device in a second mode and at least causing the display device not to display the second display prompting removal of the object.

15. The vehicle control method according to claim 14, wherein
a first emphasis degree of the first mode is a same as a second emphasis degree of the second mode.

16. The vehicle control method according to claim 14, wherein
a first emphasis degree of the first mode is larger than a second emphasis degree of the second mode.

17. The vehicle control method according to claim 10, wherein
the first object and the second object, which do not exist during the teacher traveling and exist during the autonomous traveling, are detected based on the first situation and the second situation.

18. The vehicle control method according to claim 10, wherein
the sensor device includes a camera arranged in the vehicle.

19. The vehicle control method according to claim 18, wherein
the camera includes at least a first camera, a second camera, a third camera, and a fourth camera,
the first camera is arranged in a front portion of the vehicle,
the second camera is arranged in a right portion of the vehicle,
the third camera is arranged in a left portion of the vehicle, and
the fourth camera is arranged in a rear portion of the vehicle.

20. The vehicle control method according to claim 10, wherein
the sensor device further includes at least one of a radar, a LiDAR, and a sonar.
